(19) United States
(12) Patent Application Publication
(10) Pub. No.: US 2005/0125950 A1
(43) Pub. Date: Jun. 16, 2005

(54) Hinge with a rotating function

(76) Inventor: Ding-Hone Su, Taipei Hsien (TW)

Correspondence Address: BIRCH STEWART KOLASCH & BIRCH, PO BOX 747, FALLS CHURCH, VA, 22040-0747, US

(21) Appl. No.: 10/731,092

(22) Filed: Dec. 10, 2003

(51) Int. Cl. E05F 1/08

(52) U.S. Cl. 16/302

(57) ABSTRACT

A hinge with a rotating function includes a positioning base and a rotating base. The positioning base is provided with a spinning portion and a position limiting portion for providing a rotational range, provided with at least one receiving groove, and provided with a flexible member disposed in the receiving groove and a touching member placed on the flexible member and exposed out of the receiving groove. The rotating base has a rotating portion placed in the spinning portion, provided with a limiting portion placed the rotational range and corresponding to the position limiting portion, provided with a slipping portion corresponding to the flexible member, wherein the rotating base is rotated within the rotational range by means of the rotating portion and during rotation, the damping resistance of positioning is generated by the slipping portion which presses the touching member.

### FIELD OF THE INVENTION

The present invention relates to a hinge with a rotating function, and more particularly to a hinge with a rotating function applied to the electronic device, such as a notebook computer, a personal digital assistant (PDA), a digital camera and a cellular phone, such that the cover body is corresponding to the main body to be rotated.

### BACKGROUND OF THE INVENTION

Recently, an electronic device, such as a notebook computer, a personal digital assistant (PDA), a digital camera, and a cellular phone, which has a display, mainly includes a main body of the electronic device and a cover body of the display which is pivotally connected to the main body by using a hinge. When a user wants to use the electronic device, the user only opens up the cover body of the display. When a user doesn't want to use the electronic device, the user can fold up the cover body of the display and the main body of the electronic device, so as to decrease the volume of the electronic device and easily store up and carry the electronic device.

Generally, conventional hinge structure has simple forward opening and backward folding function and therefore a user only operates the electronic device when facing to the cover body of the display. However, if the image on the display must be simultaneously viewed by a lot of persons in different angles, the whole electronic device must be rotated in a specific angle. It is not convenient for the user to operate the electronic device. Furthermore, the electronic device may be shut down during removing motion, because the electronic device is excessively shaken to affect the function of the electronic components in the electronic device. For above reason, the hinge which can be rotated in an axial direction has been developed. The above-mentioned hinge has forward opening and backward folding function and cause the cove body of the display to be rotated and to face to other users, such that other user share the image on the display.

“A panel display device and rotating structure thereof” is disclosed in Taiwan No. 495,130. The rotating structure includes a rotating base formed with a first cylindrical body and two grooves which are disposed in two sides of the first cylindrical body and corresponding to each other; a pivot pivotally connected to the connecting portion of the panel display device and the rotating base; a fixing base mounted to a computer body and formed with a second cylindrical body, which includes a aperture formed in the central portion of second cylindrical body and just receiving the rotating base and two sockets formed on the aperture and corresponding to each other; and two flexible members including a flange and received by the sockets; wherein the groove just receives the flange when the rotating base rotated to a fixing position inside the fixing base.

The above-mentioned rotating structure disclosed in the prior art describes the important design of the hinge, wherein the hinge must have a function of assembling of simple structure, provide a suitable torque during opening and folding, and provide damping resistance during rotation. However, according to the above-mentioned rotating structure, the design that the flange corresponds to the groove is not proper, and the above-mentioned rotating structure has restricted damping resistance and is only rotated within 180 degrees. In addition, the damping resistance is generated by the friction between the flange of the flexible member and the circle of the rotating base, such that the flexible member may be deformed. Accordingly, there exists a need for a hinge with a rotating function to solve the above-mentioned problem.

### SUMMARY OF THE INVENTION

It is an object of the present invention to provide a hinge with a rotating function applied to the electronic device, such as a notebook computer, a personal digital assistant (PDA), a digital camera and a cellular phone, such that the cover body is corresponding to the main body to be rotated.

In order to achieve the foregoing objects, the present invention provides a hinge with a rotating function including a positioning base and a rotating base. The positioning base is provided with a spinning portion, provided with a position limiting portion for providing a rotational range, provided with at least one receiving groove, and provided with a flexible member disposed in the receiving groove and a touching member placed on the flexible member and exposed out of the receiving groove. The rotating base has a rotating portion placed in the spinning portion, provided with a limiting portion placed the rotational range and corresponding to the position limiting portion, provided with a slipping portion corresponding to the flexible member, wherein rotating base is rotated within the rotational range by means of the rotating portion and the damping resistance of positioning during rotation is generated by the slipping portion which presses the touching member.

The hinge with a rotating function according to the present invention has the following advantages:

1. When the cover body is corresponding to the main body to be rotated within the rotational range by means of the rotating portion, and the resistance element is a polygon and provided with an opening for preventing the resistance element from deformation of heat or friction.

2. During rotation, the damping resistance of positioning is generated by the slipping portion which presses the touching member, and the slipping portion is designed in different angles, thereby increasing multi-step rotating feeling.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective schematic view of a hinge with a rotating function according to the present invention.

FIGS. 2 and 3 are perspective exploded schematic views of a hinge with a rotating function according to the present invention.

FIGS. 4A to 4D are sectional schematic views of a hinge with a rotating function according to the present invention showing an embodiment.

FIGS. 5A to 5D are top plan schematic views of a hinge with a rotating function according to the present invention showing an embodiment.

FIG. 6 is a perspective schematic view of a hinge with a rotating function according to the present invention showing the hinge assembled to an electronic device.

### DESCRIPTION OF THE PREFERRED EMBODIMENTS

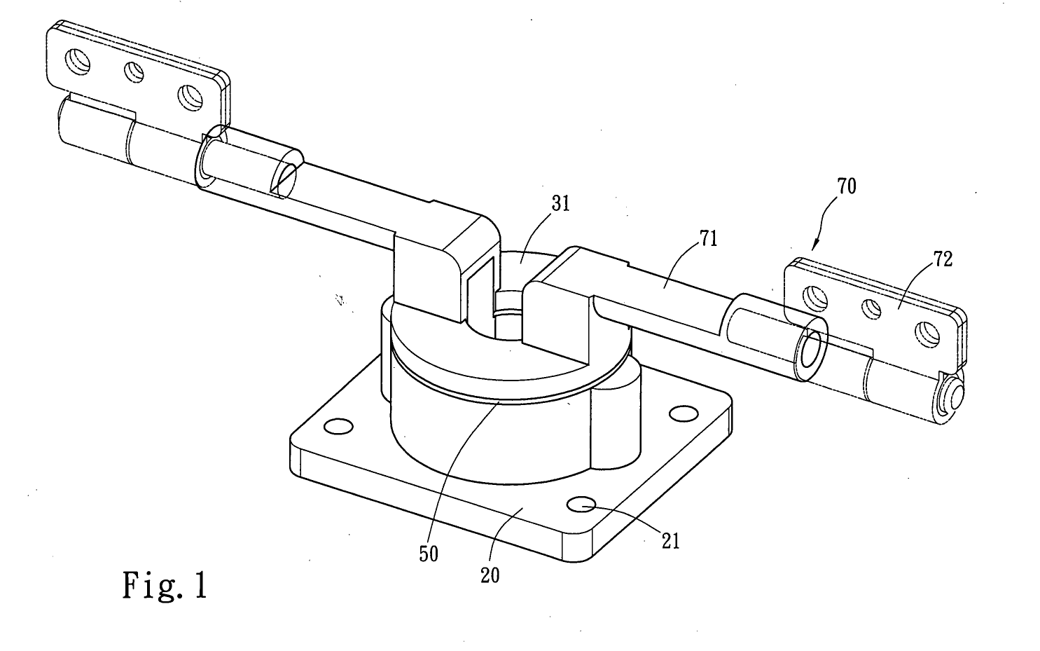

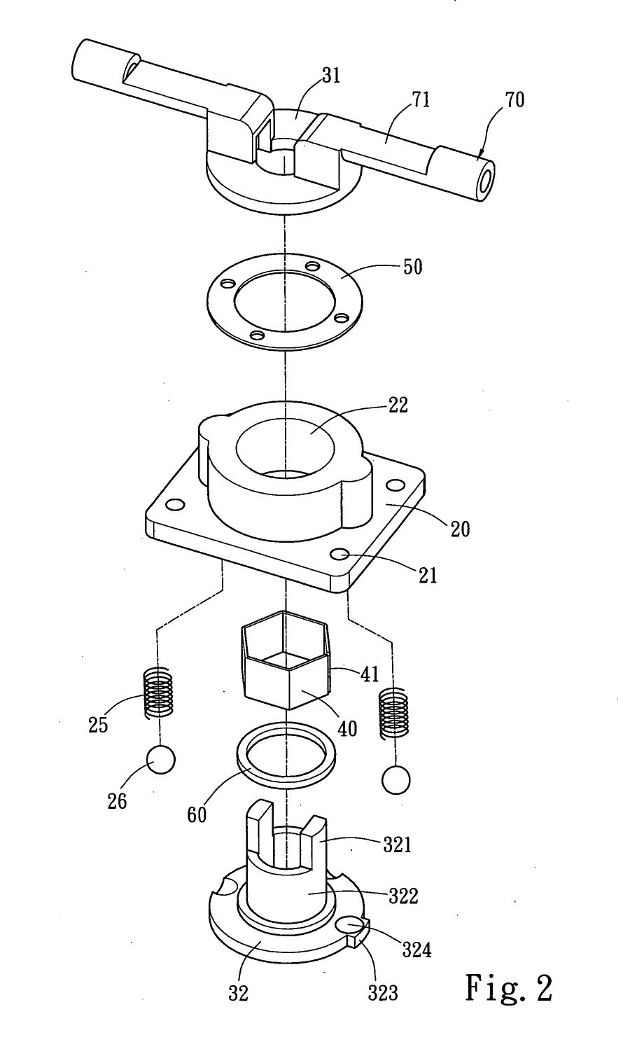

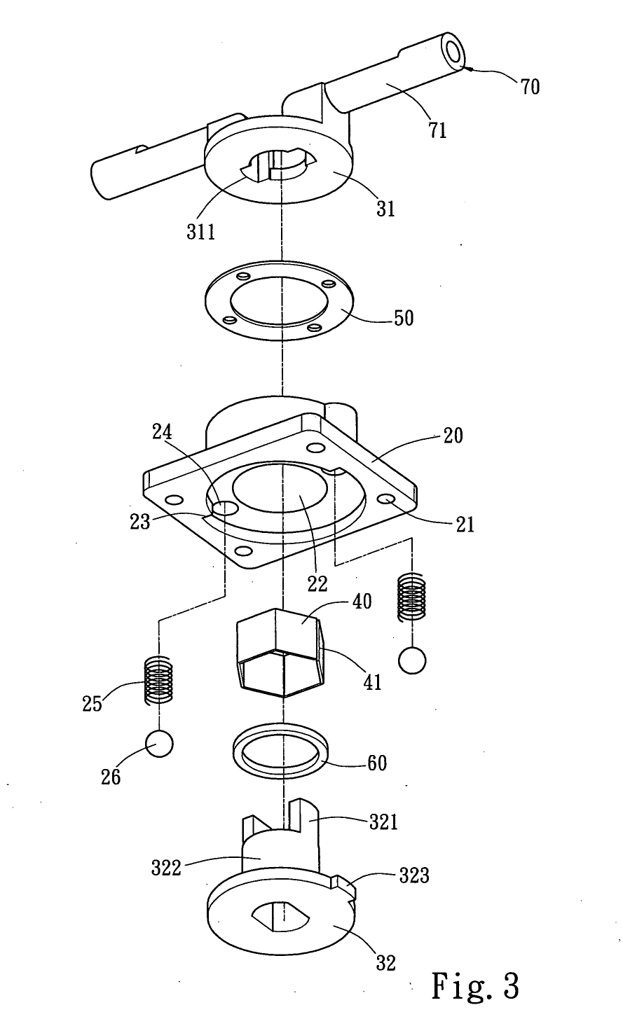

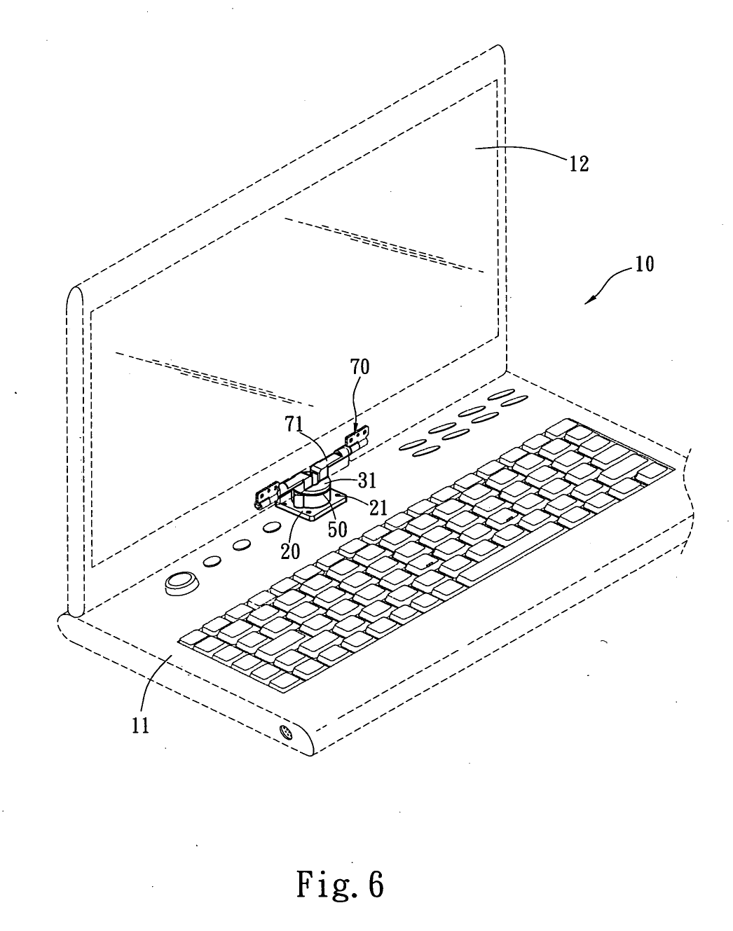

Referring to FIGS. 1, 2 and 3, they depict a perspective and exploded view of a hinge with a rotating function according to the present invention. The hinge according to the present invention is used for connecting a main body 11 to a cover body 12, such that the hinge is a pivot and further the cover body 12 is corresponding to the main body 11 to be rotated pivotally. According to the main body 11 and the cover body 12 at the electronic device 10, such as a notebook computer, a personal digital assistant (PDA), a digital camera and a cellular phone, the cover body 12 is requested and corresponding to the main body 11 to be rotated (FIG. 6 shows a embodiment of a notebook computer), wherein the hinge includes a positioning base 20 mounted on the main body 11 and a rotating assembly 70 mounted on the rotating base of the cover body 12.

The above-mentioned positioning base 20 is provided with a positioning aperture 21. The positioning base mounted on the main body 11 by using a plurality of screws (not shown in the figures) which penetrate through the positioning aperture 21. The positioning base 20 is provided with a spinning portion 22 placed on the center of the positioning base 20. The positioning base 20 is provided with a position-limiting portion 23 for providing the cover body 12 with rotational range. The positioning base is provided with at least one receiving groove 24. A flexible member 25 is disposed in the receiving groove 24, and a touching member 26 is placed on the flexible member 25 and exposed out of the receiving groove 24.

The above-mentioned rotating base has a rotating portion 322 placed in the spinning portion 22 and is provided with a limiting portion 323 which is placed the rotational range of the cover body 12 and corresponding to the proposition limiting portion 23. The signal wire of the cover body of the display which cannot be deformed is considered, and therefore the rotational range must be limited within 360 degrees (Although the rotational range of the cover body 12 of this embodiment within 180 degrees is disclosed, the rotational range in actual operation within 360 degrees can be enabled.) The rotating base is provided with a slipping portion 324 corresponding to the flexible member 25. The cover body 12 is corresponding to the main body 11 to be rotated within the rotational range by means of the rotating portion 322, and during rotation, the damping resistance of positioning is generated by the slipping portion 324 which presses the touching member 26. The rotating base includes an upper shaft base 31 and a lower rotating base 32 assembled to each other. The upper shaft base 31 and the lower rotating base 32 are respectively provided with a cavity portion 311 and a protrusion portion 321 corresponding to the cavity portion 311, and the upper shaft base 31 is used for assembling to the rotating assembly 70. The rotating portion 322 the limiting portion 323 and the slipping portion 324 are disposed under the lower rotating base 32, and a resistance element 40 is disposed between the rotating portion 322 and the spinning portion 22. The resistance element 40 is a polygon and provided with an opening 41 for preventing the resistance element 40 from slipping. In addition, a pad 50 is disposed between the rotating portion 322 and the upper shaft base 31 for decreasing friction. A pad 60 for decreasing friction is disposed between the resistance element 40 and the lower rotating base 32.

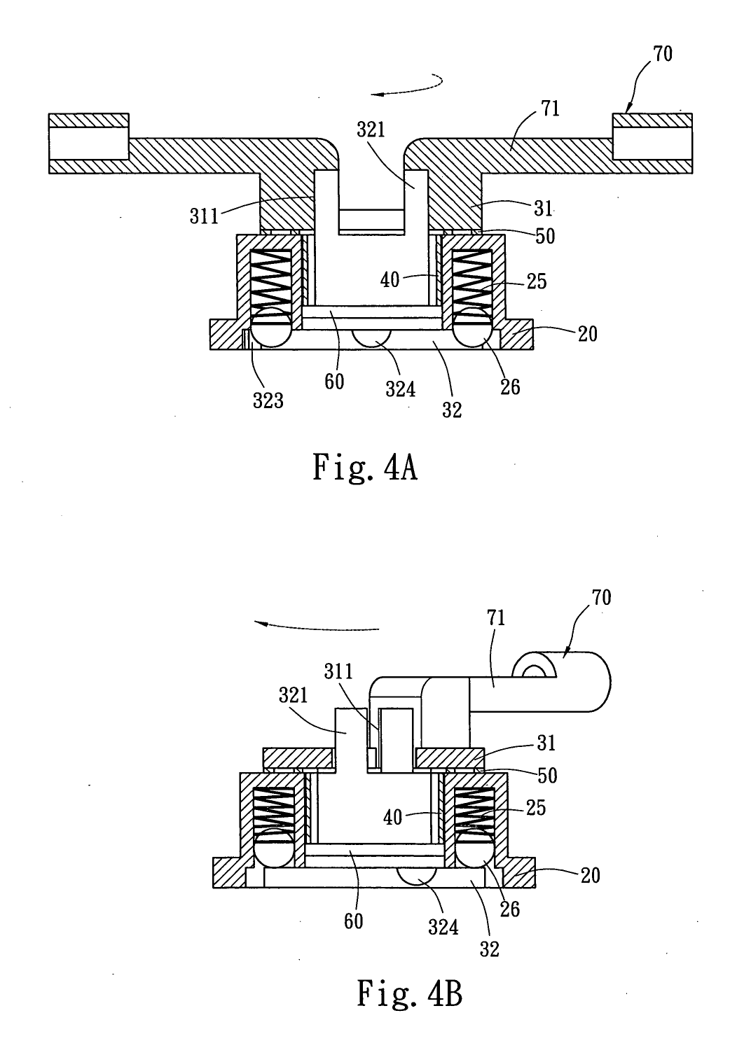

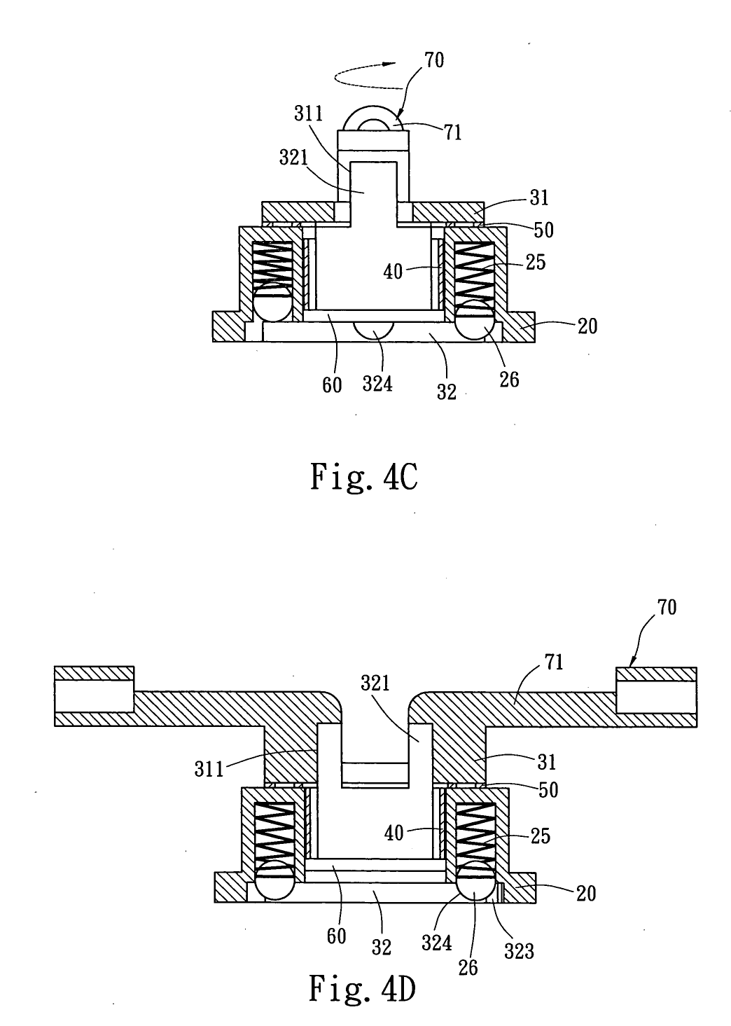

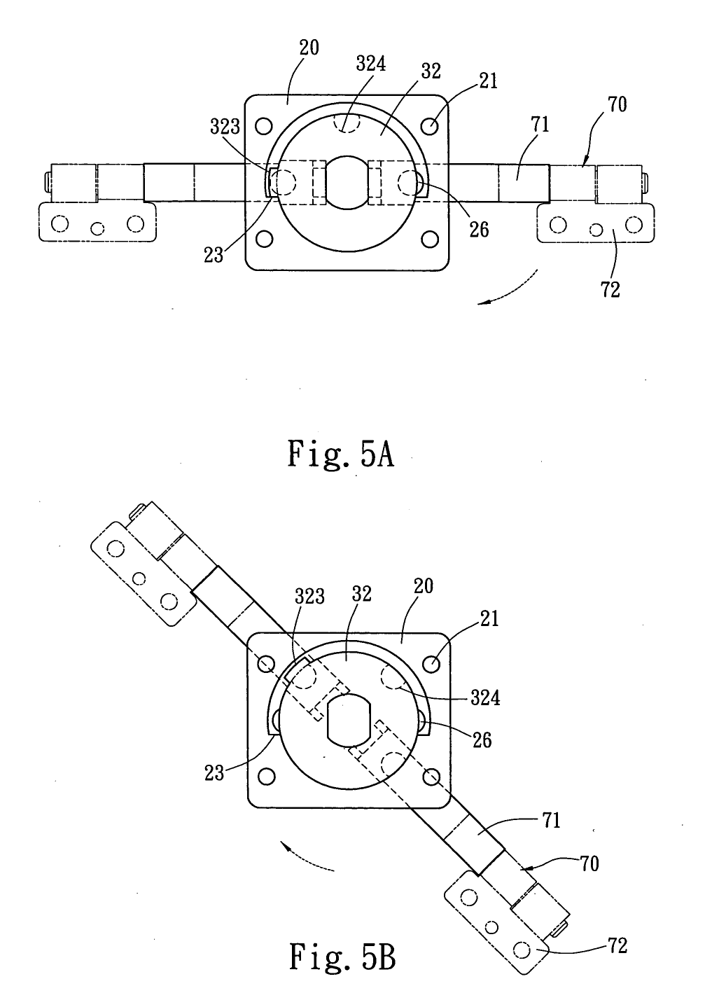

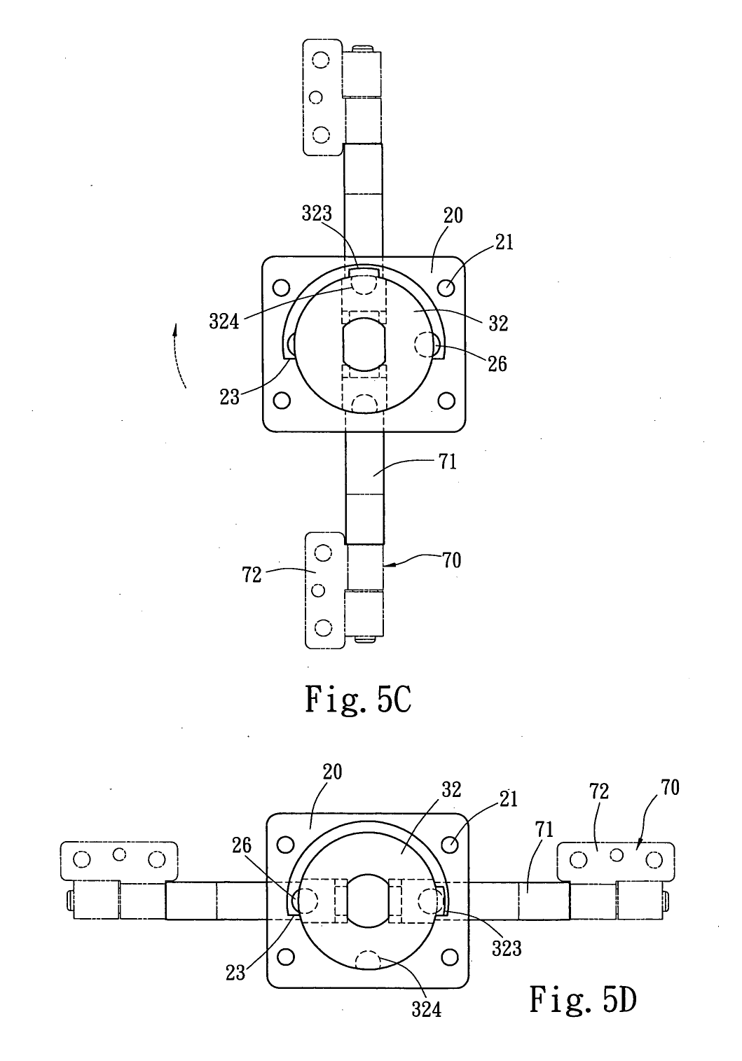

Referring to FIGS. 4A, 5A and 6, they depict a sectional and top plan schematic view of the hinge according to the present invention. As described in figure, the rotating assembly 70 is assembled to the upper shaft base 31 according to the present invention. The rotating assembly 70 includes an axial shaft 71 and a mounting element 72 pivotally connected to the axial shaft 71, wherein the axial shaft 71 and the upper shaft base 31 can be integrally designed. When the cover body 12 is rotated, the rotating assembly 70 will drive the upper shaft base 31 and further drive the lower rotating base 32 to be rotated in the spinning portion 22 by means of the rotating portion 322. The rotational torque is generated by the friction of the resistance element 40. The slipping portion 324 presses the touching member 26 in a normal direction and compresses the flexible member 25 to store elasticity (As shown in FIGS. 4B and 5B, the cover body 12 is rotated to a position of 45 degrees, the sphere-shaped touching member 26 is moved downward to compress the flexible element 25 because of displacement of the cover body 12.). The feeling of operation also is considered in the present invention, the plurality of slipping portions 324 can be designed, for example, there are three the slipping portions 324 and the distance between two of the slipping portions 324 is 90 degrees in the embodiment. As shown in FIGS. 4C and 5C, the cover body 12 is rotated to a position of 90 degrees. The flexible element 25 which has stored the elasticity can release the elasticity to push up the touching member 26, when the touching portion 26 enters the slipping portion 324, thereby providing a user with snap feeling during rotation of the cover body 12. As shown in FIGS. 4D and 5D, the cover body 12 is rotated to a position of 180 degrees and is also providing a user with snap feeling. When the lower rotating base 32 is rotated from a position of 0 degree, the limiting portion 323 departs from the position-limiting portion 23 and is simultaneously rotated. When the lower rotating base 32 is rotated to a position of 180 degrees, the limiting portion 323 is obstructed by the position-limiting portion 23, such that the cover body 12 cannot be continuously rotated. Thus, the cover body 12 can be controlled within the rotational range for preventing signal wires from deformation.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A hinge with a rotating function comprising:
a positioning base provided with a spinning portion, provided with a position limiting portion for providing a rotational range, provided with at least one receiving groove, and provided with a flexible member disposed in the receiving groove and a touching member placed on the flexible member and exposed out of the receiving groove; and
a rotating base having a rotating portion placed in the spinning portion, provided with a limiting portion placed the rotational range and corresponding to the position limiting portion, provided with a slipping portion corresponding to the flexible member, wherein the rotating base is rotated within the rotational range by means of the rotating portion and during rotation, the damping resistance of positioning is generated by the slipping portion pressing the touching member.

2. The hinge with a rotating function according to claim 1, wherein a resistance element disposed between the rotating portion and the spinning portion.

3. The hinge with a rotating function according to claim 2, wherein the resistance element is a polygon and provided with an opening for preventing the resistance element from slipping.

4. The hinge with a rotating function according to claim 1, wherein the touching member is sphere-shape.

5. The hinge with a rotating function according to claim 1, wherein the rotating base includes an upper shaft base and a lower rotating base assembled to each other.

6. The hinge with a rotating function according to claim 5, wherein the rotating portion is disposed on the lower rotating base and provided with a pad disposed between the rotating portion and the upper shaft base.
